(19) United States
(12) Patent Application Publication
(10) Pub. No.: US 2004/0252351 A1
(43) Pub. Date: Dec. 16, 2004

(54) Operation panel for image forming apparatus

(75) Inventor: Takanori Fukuhara, Shizuoka-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/457,463

(22) Filed: Jun. 10, 2003

(51) Int. Cl. H04N 1/04

(52) U.S. Cl. 358/474

(57) ABSTRACT

An imaging device is provided with a selectable menu of imaging options, and a display configured to display a representation of an item to be imaged as selected.

### BACKGROUND OF THE INVENTION

A. Field of the Invention

The present invention relates generally to the field of imaging devices, and more particularly, to a method of and apparatus for depicting selected imaging options on an imaging device.

B. Background of the Invention

Known photocopier devices include an operation panel for depicting imaging options on the photocopier device, and an interface for selecting desired imaging options for a particular copy job. By way of example, a user may select an “N-up” copy having a 4:1 N-up ratio, where an N-up copy takes N pages at a first size (e.g., 8.5″×11″) and combines the N pages onto a selected number of pages. Hence a 4:1 N-up ratio takes 4 pages at a first size and combines the 4 pages onto a single page (i.e., 4:1).

In the above referenced example, the user has selected a 4:1 N-up copy on 1 side. The 4:1 N-up copy on 1 side, however, is not conveyed to the user in any other manner than by highlighting the selections (e.g., by creating a visual image of an “N-up” imaging option “depressed” in the operation panel) as the user selects the various imaging options. Thus, if the user selected a 4:1 N-up copy on one side where the user actually intended to select a 2:2 N-up copy double sided, the user has no way of easily confirming that the proper selection has been made until the print job is completed.

Moreover, a given user may frequently use the same “complex” copy job; i.e., a combination of various imaging options on the imaging device. By way of example, a marketing person may often use the 4:1 N-up copy on 1 side for creating marketing brochures or pamphlets. Known photocopier operation panels, however, do not include a memory function for creating a new identification of the often used 4:1 N-up copy on 1 side; hence the marketing individual must parse through all of the desired imaging options each time the marketing individual uses the photocopier device for this typical type of copy project.

### SUMMARY OF THE INVENTION

According to one embodiment of the present invention, a method of depicting selected imaging options on an imaging device is provided, comprising depicting a plurality of imaging options on a first display, selecting a first imaging option from the plurality of imaging options, and depicting a representation of the item imaged as selected.

According to another embodiment of the present invention, an imaging device is provided, comprising a selectable menu of imaging options, and a display configured to display a representation of an item to be imaged as selected.

According to another embodiment of the present invention, an imaging device is provided, comprising means for depicting a plurality of imaging options on a first display, means for selecting a first imaging option from the plurality of imaging options, means for depicting a representation of the item imaged as selected, and means for imaging the item as selected.

According to another embodiment of the present invention, a computer readable medium comprising machine readable code is provided for causing an imaging device to perform the method steps of depicting a plurality of imaging options on a first display, selecting a first imaging option from the plurality of imaging options, and depicting a representation of the item imaged as selected.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a perspective view showing an item to be imaged being loaded in a photocopier device according to an embodiment of the present invention.

FIG. 2 is a block diagram of components of a photocopier device according to an embodiment of the present invention.

FIG. 3A and 3B show a first display device and a second display device according to an embodiment of the present invention.

FIG. 4A and 4B show a first display device and a second display device according to an embodiment of the present invention.

FIG. 5 is a flow chart of a method of depicting selected imaging options according to an embodiment of the present invention.

FIG. 6 is a flow chart of a method of registering an icon according to an embodiment of the present invention.

FIG. 7 is a first display device depicting one of a plurality of menus according to the present invention.

FIG. 8 is a first display device depicting another of a plurality of menus according to the present invention.

### DETAILED DESCRIPTION OF PREFERRED EMBODIMENTS

Reference will now be made in detail to exemplary embodiments of the present invention. Wherever possible, the same reference numbers will be used throughout the drawings to refer to the same or like parts.

For purposes of explanation only, the following description will refer to a photocopier device 100. It should be appreciated, however, that the present invention is not limited to photocopier devices, but may also include, for example, facsimile machines, printers, etc.

In addition, the following description will also refer to a “representation” depicted by the photocopier device 100. The term “representation” refers to a graphical (e.g., 2-dimensional) image that conveys to a user some visual impression of what a copy job will look like. By way of example, a representation may include a two dimensional icon of a stack of stapled paper. Hence, it should be appreciated that a light next to a text indicating the same (e.g., a light next to “double sided” to indicate a double sided job is selected) is not intended to be a representation, because it does not graphically convey a visual impression of what the copy job will look like.

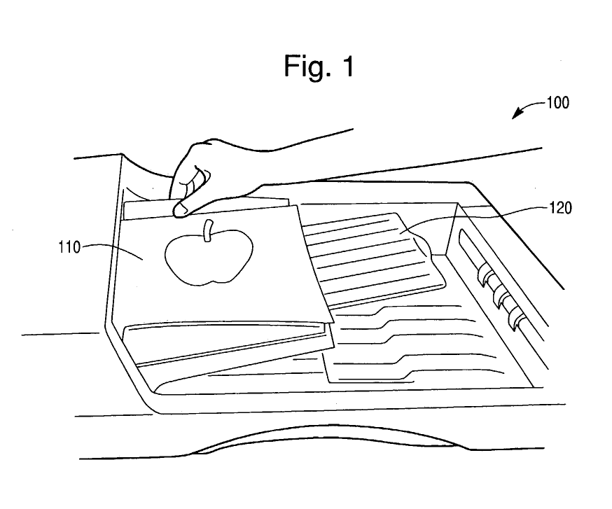

A photocopier device 100 according to a first embodiment of the present invention is shown in the simplified view of FIG. 1. The photocopier 100 is depicted with an item to be imaged 110 placed within the automatic sheet feeder 120. Other configurations are also plausible, as would be readily apparent to one of ordinary skill in the art after reading this disclosure.

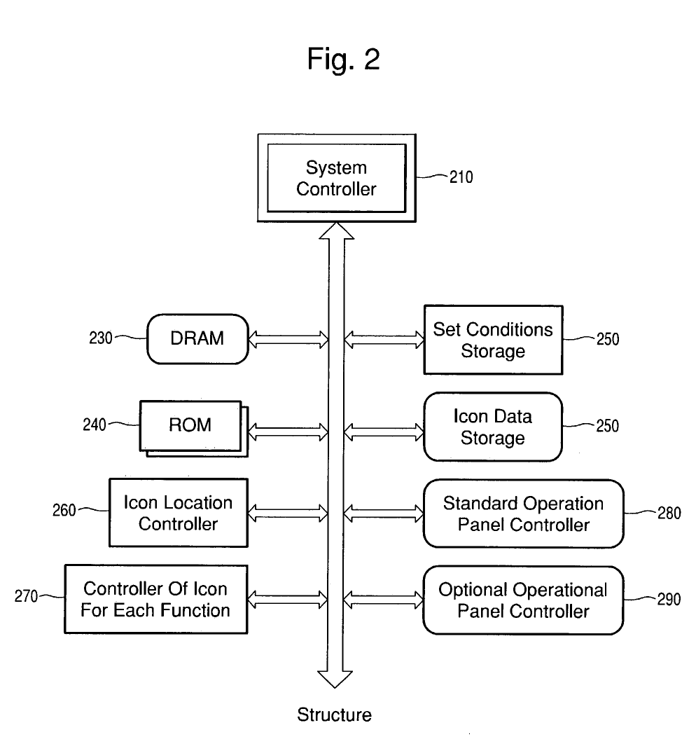

As shown in FIG. 2, the photocopier device 100 includes a system controller 210 programmed to perform various control functions to be described in greater detail below. The system controller 210 may comprise, for example, a processor configured to communicate with various photocopier components via system bus 220, such as a DRAM 230 for temporarily storing imaging related data, a ROM 240 for loading photocopier operating code, a set condition storage device 250 for storing set conditions of the photocopier device, etc. The set condition storage 250 manages setting information of an operation, such as a copy function, a facsimile function, and a print function. The setting information of an operation includes, for example, form size selection, magnification selection, sorting conditions, finishing conditions, and any other settings that are relevant or needed for the operation.

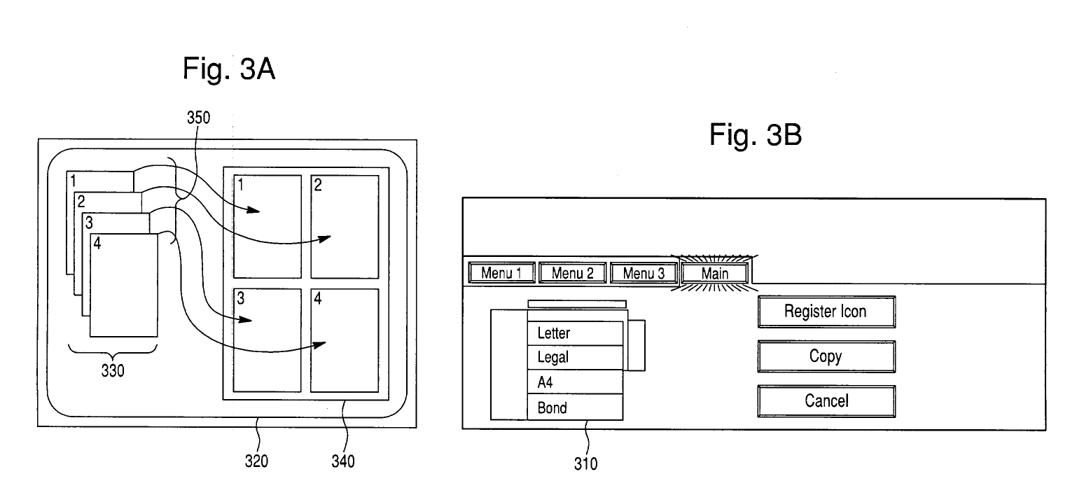

The system controller 210 is further configured to access an icon data storage device 250, which stores graphical data for displaying a given icon on a first display device 310 and/or a second display device 320 (FIG. 3). The particular storage location (e.g., a preference list, a frequently used list, etc.) of a given icon and/or the particular display 310, 320 on which the icon will be displayed, as will be described in detail below, may be controlled by icon location controller 260. In order to correlate a given icon with a selected imaging option, controller 270 may be provided separate from or part of the icon location controller 260.

The first display device 310 is controlled by standard operation panel controller 280 (via system controller 210), and configured to display a menu of imaging options available on the photocopier device 100. The first display device 310 preferably comprises a touch screen display, such that the imaging options can be selected by a user “touching” the item in the menu of imaging options. The second display device 320 is controlled by optional operation panel controller 290, and is configured to display a representation (e.g., an icon) of an item imaged as selected, which will be described in greater detail below. The first display device 310 and the second display device 320 may be discrete display devices as shown in FIG. 3, or may each comprise portions of an integral display device (not shown).

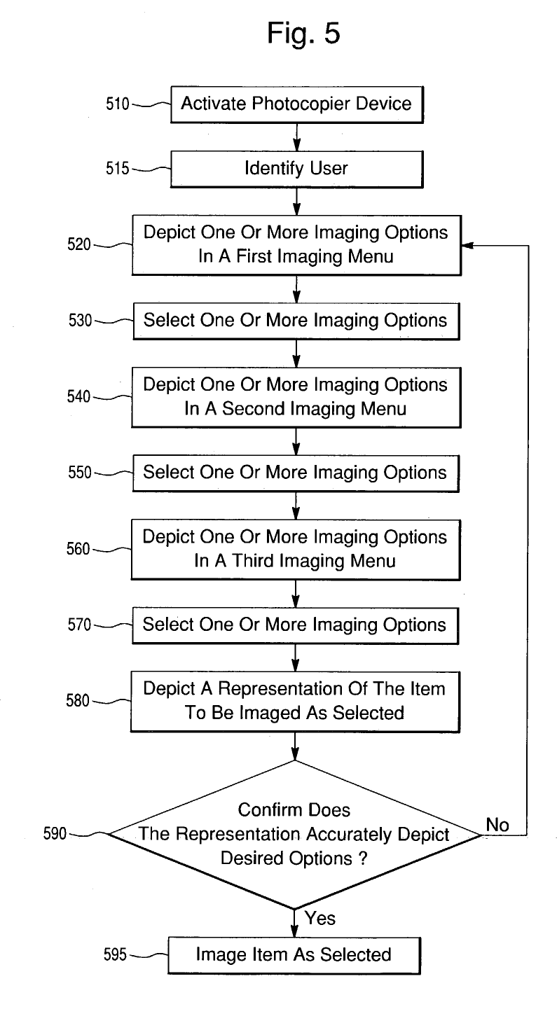

Operation of the photocopier device 100 will now be set forth in greater detail with reference to FIG. 5. In step 510, a user begins the photocopying process by activating the photocopier device 100. Such activation may occur, for example, by simply touching the first display 310 if it is a touch screen display to “awaken” the photocopying device 100 from a sleep mode, or by turning on a powered down photocopying device 100. Activation may also include a user identifying himself or herself in step 515, as will be described in greater detail below.

Once the photocopying device 100 is activated, the first display device 310 depicts one or more imaging options in a first imaging menu in step 520. Preferably, the first imaging menu includes basic imaging options, such as paper size (e.g., 8.5″×11″, A4, etc.), paper source (e.g., tray 1, tray 2, manual feed, etc.), paper orientation, contrast, etc. The user then selects one or more imaging options (e.g., 8.5″×11″ paper from manual feed) in step 530. Optionally, the photocopier device 100 may automatically select one or more imaging options by default, such that the default selections are set unless the user overrides the default selection by selecting one or more different imaging options in step 530.

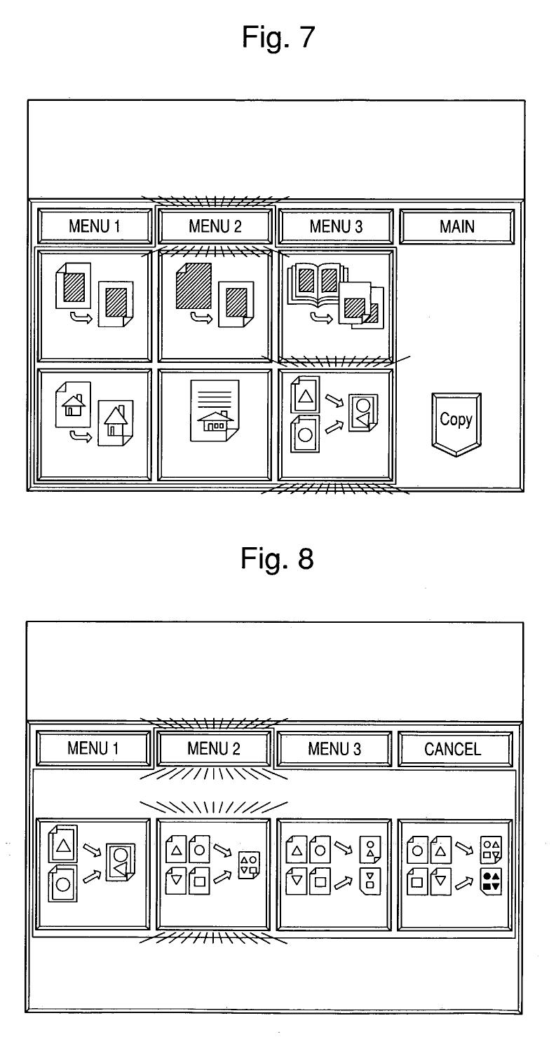

Once the user has selected one or more imaging options in step 530, the first display device 310 preferably depicts one or more imaging options in a second imaging menu in step 540. The second imaging menu may include, for example, more advanced imaging options than the basic imaging options of the first imaging menu as shown in FIG. 7, such as an N-up option (highlighted), a resizing option, a re-cropping option, double sided option, a rotation option, a sorting option, a stapling option, etc.

Once the user has selected one or more imaging options in step 550, the first display device 310 may depict one or more imaging options in a third imaging menu in step 560. Preferably, the third imaging menu is a subset of one or more selected options from the second imaging menu as shown in FIG. 8. By way of example, if an N-up copy option is selected in step 550, the third imaging menu may display a number of N-up variations (e.g., 4:2, 4:1, 3:1, etc.). The user then selects one or more imaging options (e.g., a 4:1 option) in step 570. Optionally, the photocopier device 100 may again select one or more imaging options by default, such that the default selections are set unless the user overrides the default selection by selecting one or more different imaging options in step 570.

It should be appreciated that although three menus are described above, any number of menus (e.g., one, two, three, four, etc.) can be used, as would be readily apparent to one of ordinary skill in the art after reading this disclosure.

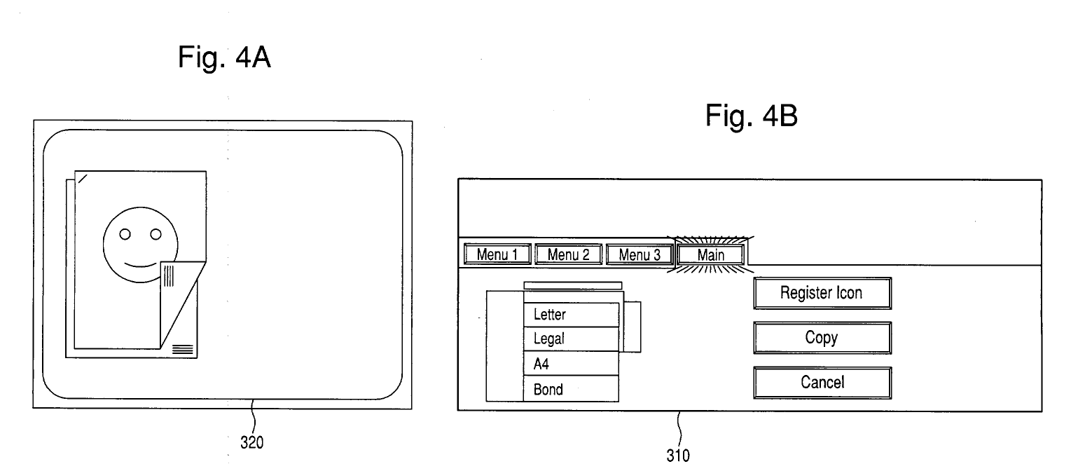

After the user has selected the various imaging options desired, the photocopier device then displays in step 580 a representation of the item to be imaged as selected on the second display device 320. Thus, as shown, for example, in FIG. 3A, a single sided, 4:1, stapled print job 330 would appear as a representation 340 of a single sided, 4:1, stapled stack of papers. Similarly, as shown in FIG. 4A, a representation of a double sided, stapled stack of papers could be generated if these options were selected. The graphical data required to display the representation 340 may be retrieved from data storage device 250 (FIG. 2), or can be generated by the system controller 210 “on the fly” based on the selected imaging options in steps 530, 550, 570. As shown in FIGS. 3B and 4B, the first display device 310 depicts the presently viewed menu for selecting various imaging options.

Preferably, the photocopier device 100 also displays in step 580 an animation showing at least a part of the selected options. Thus, as shown in FIG. 3A, for example, the photocopying device 100 may show four separate pages 1, 2, 3, 4 of print job 330 being shrunk and moved onto their respective locations on a single page (i.e., representation 340) for the 4:1 selected N-up option. It should be appreciated that “animation” may or may not include apparent movement in the displayed animation, such as blinking lines or waving lines 350.

Once the representation 340 is displayed in step 580, the user then confirms in step 590 whether the representation accurately depicts the desired options. Such confirmation can be achieved, for example, by selecting a button (e.g., “image now”), or by a countdown timer set to give the user a predetermined amount of time to “cancel” the print job. Other confirmation procedures are also plausible, as would be readily apparent to one of ordinary skill in the art after reading this disclosure.

If the representation 340 displayed in step 580 is accurate, the item is imaged as selected in step 595. If not, the process returns to step 520 such that the user can re-select the desired imaging options. Optionally, step 590 may allow the user to return to an intermediate selection step (e.g., step 550 or 570) to correct selected sub options from the second or third menus (e.g., change a 4:1 N-up copy to a 2:1 N-up copy).

The above referenced photocopier device 100 thus provides a user with a graphical representation of the item to be imaged, which aids the user in visualizing the selected print job. The graphical representation allows the user to confidently and easily confirm that the print job will result in the desired format, and provides the user with an opportunity to cancel or alter the print job if needed.

According to one embodiment of the present invention, the user identifies himself or herself in step 515, e.g., with a unique identification code. The user can then select from “custom” imaging option(s) in steps 530, 550, 570, such that the representation of the item to be imaged as displayed in step 580 is retrieved from a group of imaging options specific to that particular user. This allows the photocopier device 100 to be customized for individual users.

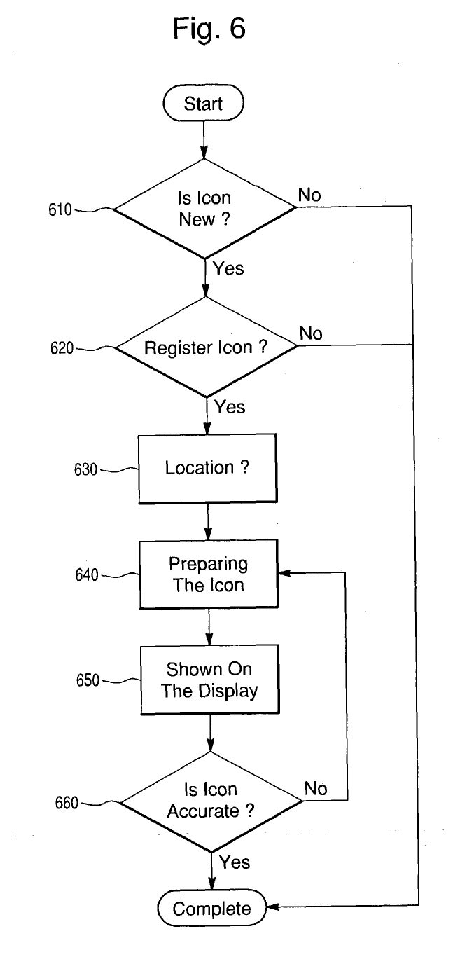

According to another embodiment of the present invention, the photocopier device 100 can preferably generate and/or store the representation (e.g., an icon) of the selected options for future use. In general, an icon is a graphical representation of a set of selected conditions. Hence, many icons can be pre-generated and stored as part of the operating software for the photocopier device for commonly selected conditions (e.g., double-sided imaging, a stapled stack, etc.). Thus, as shown in FIG. 6, the photocopier device 100 first determines whether the icon is new in step 610. By way of example, if the user selects a custom icon in one of steps 530, 550, and 570 then the photocopier device 100 may presume the icon is already registered. If the representation is already registered, the process terminates.

If the representation is not already registered, the photocopier device 100 may query the user whether the user would like to register the representation in step 620. Such a query may include, for example, a displayed message on the second display unit such as “Register Copy Job For Future Use?” followed by touch activated “YES” and “NO” buttons. If the user selects “NO” (or if the user fails to select either yes or no), the process terminates.

If the user selects “YES” in step 620, the photocopier device 100 determines a location to store the representation in step 630. Such a location may include, for example, a stored preference list particular to a given user, a frequently used list, etc. Other storage locations are also plausible, as would be readily apparent to one of ordinary skill in the art after reading this disclosure.

The photocopier device 100 then prepares a representation of the selected options in step 640. By way of example, the representation of selected options may be the same representation as displayed by the second display device 320 in step 580. Alternatively, other representations may also be used, such as a brief description of the selected options in tabular form.

The prepared representation of the selected options is then displayed on the second display device 320 in step 650. Preferably, the user then confirms storage of the representation in step 660. If the user does not confirm storage of the representation in step 660, the photocopier device 100 may then query the user whether to generate a different representation of the selected options via repeating step 640, or to terminate the process. Once the user has confirmed storage of the representation in step 660, the representation is then stored for future use.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A method of depicting selected imaging options on an imaging device, comprising:
depicting a plurality of imaging options on a first display;
selecting a first imaging option from said plurality of imaging options; and
depicting a representation of said item imaged as selected.

2. The method of claim 1,
wherein depicting a plurality of imaging options depicts a menu of imaging options on a first display, and
wherein depicting a representation of said item imaged as selected depicts said item on a second display distinct from said first display.

3. The method of claim 1, further comprising:
selecting a second imaging option distinct from said first imaging option.

4. The method of claim 1, further comprising:
animating said item so as to show creation of said item imaged as selected prior to imaging into said item imaged as selected.

5. The method of claim 1, further comprising:
generating said representation of said item imaged as selected; and
storing said representation of said item imaged as selected as an imaging option for said imaging device.

6. The method of claim 5, further comprising:
storing a user name relating to said representation of said item imaged as selected,
wherein storing said representation of said item imaged as selected stores said representation in a group of imaging options specific to said user name.

7. The method of claim 1, wherein said imaging option comprises at least one of a resizing option, a re-cropping option, an N-up option, a double sided option, a rotation option, a sorting option, and a stapling option.

8. The method of claim 1, wherein said imaging device comprises one of a photocopier, a facsimile machine, and a printer.

9. The method of claim 1, further comprising:
identifying a user of said imaging device;
wherein said depicting a plurality of imaging options depicts at least one imaging option previously used by said user.

10. The method of claim 1, further comprising:
offering a user an option of canceling selected imaging options if said representation does not correspond to a desired print job.

11. An imaging device, comprising:
a selectable menu of imaging options; and
a display configured to display a representation of an item to be imaged as selected.

12. The imaging device of claim 11, wherein said display comprises:
a first display configured to display said selectable menu of imaging options; and
a second display configured to display said representation,
wherein said first display and said second display are distinct display units.

13. The imaging device of claim 11, further comprising:
a storage device; and
a processor in communication with said storage device, said processor being programmed to:
generate said representation of said item imaged as selected; and
store said representation in said storage device.

14. An imaging device, comprising:
means for depicting a plurality of imaging options on a first display;
means for selecting a first imaging option from said plurality of imaging options;
means for depicting a representation of said item imaged as selected; and
means for imaging the item as selected.

15. The imaging device of claim 14, further comprising:
means for animating said item prior to imaging.

16. The imaging device of claim 14, further comprising:
means for storing said representation for future use.

17. A computer readable medium comprising machine readable code for causing an imaging device to perform the following method steps:
depicting a plurality of imaging options on a first display;
selecting a first imaging option from said plurality of imaging options; and
depicting a representation of said item imaged as selected.

18. The computer readable medium of claim 17, further comprising machine readable code for causing the imaging device to perform a method step of:
selecting a second imaging option distinct from said first imaging option.

19. The computer readable medium of claim 17, further comprising machine readable code for causing the imaging device to perform a method step of:
animating said item so as to show creation of said item imaged as selected prior to imaging into said item imaged as selected.

20. The computer readable medium of claim 17, further comprising machine readable code for causing the imaging device to perform method steps of:
generating said representation of said item imaged as selected; and
storing said representation of said item imaged as selected as an imaging option for said imaging device.

21. The computer readable medium of claim 17, further comprising machine readable code for causing the imaging device to perform a method step of:
storing a user name relating to said representation of said item imaged as selected,
wherein storing said representation of said item imaged as selected stores said representation in a group of imaging options specific to said user name.

22. The computer readable medium of claim 17, further comprising machine readable code for causing the imaging device to perform method step of:
identifying a user of said imaging device;
wherein depicting a plurality of imaging options depicts at least one imaging option previously used by said user.

23. The computer readable medium of claim 17, further comprising machine readable code for causing the imaging device to perform method step of:
offering a user an option of canceling selected imaging options if said representation does not correspond to a desired print job.
